(19) United States
(12) Patent Application Publication
(10) Pub. No.: US 2024/0271755 A1
(43) Pub. Date: Aug. 15, 2024

(54) CRYOGENIC FLUID DELIVERY SYSTEM AND AIR CONDITIONING APPARATUS USING SAME

(71) Applicant: GREEN KINOKO LTD, Shefayim (IL)

(72) Inventors: Ron ARAZI, Tel Aviv (IL); Iris SHIMONOV-BENYAMIN, Tel Aviv (IL); Tal LAZIER, Zichron Yaakov (IL)

(21) Appl. No.: 18/567,103

(22) PCT Filed: Jun. 7, 2022
(86) PCT No.: PCT/IL2022/050604

§ 371 Date: Dec. 5, 2023

(30) Foreign Application Priority Data
Jun. 8, 2022 (IL) 283826

(51) Int. Cl. F17C 9/02

(52) U.S. Cl. CPC F17C 9/02; F17C 2221/014; F17C 2221/031; F17C 2225/0123; F17C 2250/043

(57) ABSTRACT

Some embodiments related to a cryogenic fluid delivery system for use with a cryogenic fluid tank and a tank connector device for connecting the cryogenic fluid tank to the cryogenic fluid delivery system. The cryogenic fluid delivery system can have a tank engaging member configured to be attached to the cryogenic fluid tank, at least one dispensing member configured to dispense cryogenic fluid, and a vaporizer module comprising a boiling chamber configured to receive liquid cryogenic fluid and to allow the liquid cryogenic fluid positioned therein to boil into a gaseous cryogenic fluid, and to facilitate delivery thereof, in an unpressurized manner, towards the at least one dispensing member.

### CROSS-REFERENCE TO RELATED APPLICATIONS

This application is a national phase filing under 35 C.F.R. § 371 of and claims priority to PCT Patent Application No. PCT/IL2022/050604, filed on Jun. 7, 2022, which claims the priority benefit under 35 U.S.C. § 119 of Israeli Patent Application No. 283826, filed on Jun. 8, 2021, the contents of each of which are hereby incorporated in their entireties by reference.

### TECHNOLOGICAL FIELD

The presently disclosed subject matter relates to the field of air conditioning apparatuses, particularly, to air conditioning apparatuses utilizing release of cryogenic fluids to the immediate surroundings thereof.

### BACKGROUND

Examples of vehicles of the kind to which the presently disclosed subject matter refers are disclosed in:
U.S. Pat. No. 5,960,635, which discloses an air conditioning apparatus using liquid nitrogen having a source of liquid nitrogen in a pressure vessel, a release valve that releases the liquid nitrogen from the pressure vessel into a housing to absorb latent heat and become nitrogen gas. The apparatus further comprising a thermostat that controls the release valve and a dehumidifying arrangement that blows warmer air from outside the housing to mix with the nitrogen gas inside the housing to become a cooler air mixture. The dehumidifying arrangement further dehumidifies the cooler air mixture before directing the cooler air mixture to the atmosphere outside the housing; and
KR101666183, which discloses a cooling device for discharging oxygen having a cooling air discharge unit formed at an upper end of the main body, wherein the lower cover is detachably attached to the lower end of the main body, And a control unit for controlling the amount of oxygen gas discharged from the filling container, wherein the oxygen gas discharged from the at least one liquefied oxygen (LOX) filling container is discharged through the blowing fan And at least one discharge tube for guiding the discharge tube to discharge.

### GENERAL DESCRIPTION

In accordance with a first aspect of the presently disclosed subject matter there is provided a cryogenic fluid delivery system for use with a cryogenic fluid tank, comprising:
a. a tank engaging member configured to be fixedly attached to said cryogenic fluid tank and to selectively allow cryogenic fluid flow out of said tank and into the system,
b. a dispensing member configured to dispense cryogenic fluid out to an exterior of the system; and
c. a vaporizer module fluidly connecting said tank engaging member and dispensing portion, and comprising a boiling chamber having a liquid receiving portion configured to receive liquid cryogenic fluid and a gas releasing portion allowing liquid cryogenic fluid positioned therein to boil into a gaseous cryogenic fluid, and to facilitate delivery thereof, in an unpressurized manner, towards the dispensing member.

The first aspect can include at least the embodiments listed below.

1. A cryogenic fluid delivery system for use with a cryogenic fluid tank, comprising:
a. a tank engaging member configured to be fixedly attached to said cryogenic fluid tank and to selectively allow cryogenic fluid flow out of said tank and into the system,
b. a dispensing member configured to dispense cryogenic fluid out to an exterior of the system, and to be held, at least in operation of the system, at an elevated position relative to the tank engaging member; and
c. a vaporizer module fluidly connecting said tank engaging member and dispensing portion, and comprising a boiling chamber having a liquid receiving portion configured to receive liquid cryogenic fluid and a gas releasing portion allowing liquid cryogenic fluid positioned therein to boil into a gaseous cryogenic fluid, and to facilitate delivery thereof, in an unpressurized manner, towards the dispensing member.

2. The cryogenic fluid delivery system of embodiment 1, wherein the boiling chamber comprising:
a. a liquid receiving container constituting the liquid receiving portion, comprising a liquid cryogenic fluid inlet being in fluid communication with the tank engaging member and a liquid outlet;
b. a gas dispensing container constituting the gas releasing portion, comprising a fluid inlet in fluid communication with the liquid outlet of the liquid receiving container and a gaseous outlet in fluid communication with the dispensing member; and
c. a flow arresting member configured to selectively arrest the liquid communication between the liquid receiving container and the gas dispensing container when a predetermined amount of liquid is found/positioned within the gas dispensing tank.

3. The cryogenic fluid delivery system of embodiment 2, wherein the flow arresting member comprises a float member located within the gas dispensing container and a plug member located within the liquid receiving container and being connected to said float member by a connecting element, wherein said plug member is configured with a shape suitable to plug the liquid outlet of the liquid receiving container.

4. The cryogenic fluid delivery system of embodiment 3, wherein the liquid receiving container is positioned adjacently below the gas dispensing container and the liquid outlet of the liquid receiving container is positioned adjacently below the fluid inlet of the gas dispensing container.

5. The cryogenic fluid delivery system of embodiment 4, wherein the connecting element is a metallic rod extending from the float member, through the fluid inlet of the gas dispensing container and the liquid outlet of the liquid receiving container to the plug member.

6. The cryogenic fluid delivery system of any one of embodiments 3 to 5, wherein the float member is configured with dimensions and density sufficient to allow float in the type of cryogenic fluid stored in the cryogenic fluid tank.

7. The cryogenic fluid delivery system of embodiment 6, wherein the float is formed from a material suitable for work with cryogenic fluids.

8. The cryogenic fluid delivery system of embodiment 7, wherein the float is formed from Polyoxymethylene.

9. The cryogenic fluid delivery system of any one of embodiments 3 to 8, wherein the float member is configured with a similar but smaller cross section to the cross section of the gas dispensing container.

10. The cryogenic fluid delivery system of any one of the preceding embodiments, wherein the cryogenic fluid delivery system is ambient.

11. The cryogenic fluid delivery system of any one of the preceding embodiments, wherein the cryogenic fluid delivery system is at least partly free of thermal insulation.

12. The cryogenic fluid delivery system of embodiment 11, wherein at least a portion of the boiling chamber is configured with an insulating layer.

13. The cryogenic fluid delivery system of embodiment 12, wherein the insulating layer is configured to enable dressing and removing thereof from the boiling member.

14. The cryogenic fluid delivery system of any one of embodiments 1-13, further comprising a pressurizing arrangement configured to controllably exert pressure on the cryogenic fluid within the boiling member.

15. The cryogenic fluid delivery system of embodiment 14, wherein the pressurizing arrangement comprises at least one heating element configured to apply heat, at least indirectly, to the interior of the boiling member, and a pressure sensor configured to measure the gas pressure within the interior of the boiling member.

16. The cryogenic fluid delivery system of embodiment 14 or 15, wherein the pressurizing arrangement is configured to be operated by an independent power source.

17. The cryogenic fluid delivery system of any one of the preceding embodiments, wherein the cryogenic fluid is a non-toxic cryogenic liquid.

18. The cryogenic fluid delivery system of embodiment 17, wherein the cryogenic fluid is liquid nitrogen.

19. The cryogenic fluid delivery system of embodiment 17, wherein the cryogenic fluid is liquid Air.

20. The cryogenic fluid delivery system of any one of the preceding embodiments, wherein the boiling chamber further comprises a safety arrangement configured to prevent liquid cryogenic fluid from leaving the system.

21. An air conditioning apparatus for use with a cryogenic fluid tank, comprising a housing having a tank receiving portion at a bottom end thereof configured to house a cryogenic fluid tank, a hollow neck extending vertically upwards from said tank receiving portion and configured to house the cryogenic fluid delivery system of any one of embodiments 1-20 therein, and a dispensing portion at an upper portion of the housing configured to house the dispensing member of said cryogenic fluid delivery system.

22. The air conditioning apparatus of embodiment 21, wherein the neck is configured with an elongation mechanism, so as to enable said neck portion to increase and decrease its length, and respectively, increase and decrease the distance between the tank receiving portion and the dispensing portion.

23. The air conditioning apparatus of embodiment 21 or 22, wherein the neck portion having a footprint substantially smaller than the tank receiving portion and the dispensing head.

24. The air conditioning apparatus of any one of embodiments 21 to 23, wherein the dispensing portion is configured to be positioned, at least in operation of the apparatus, between 1-3 meters above the tank receiving portion.

25. The air conditioning apparatus of any one of embodiments 21 to 24, wherein the apparatus further comprises a scale configured to measure the amount of cryogenic fluid stored within the cryogenic fluid tank.

26. The air conditioning apparatus of embodiment 25, wherein the weight measuring arrangement comprises a communication module configured to transmit said measurements to at least one remote device.

27. The air conditioning apparatus of any of embodiments 21 to 26, wherein the air conditioning apparatus further comprises a cryogenic gas saving module configured to convey cold that is generated about the boiling chamber following operation thereof to the exterior of the housing, while arresting cryogenic fluid flow towards the boiling chamber.

28. The air conditioning apparatus of embodiment 27, wherein the cryogenic gas saving module comprises a cryogenic valve that interconnects the tank engaging member and the boiling chamber, and is configured to arrest the fluid flow thereof when a predetermined amount of cold is accumulated thereabout, and convection element configured to generate air flow for facilitating/conveying said accumulated cold to the exterior of the housing.

29. The air conditioning apparatus of embodiment 28, wherein the cryogenic valve is normally opened and is configured to be closed when the temperature and the convection element are operated by electricity.

In accordance with a second aspect of the presently disclosed subject matter there is provided a tank connector apparatus for connecting a cryogenic fluid tank comprising a neck and an inner container having a bottom, a top constituted by the neck and sidewalls extending therebetween to a cryogenic fluid delivery system comprising a cryogenic liquid inlet, comprising:
a. a tank attachment arrangement configured to be fitted about the neck of the cryogenic fluid tank in a fluid-tight manner, said tank attachment arrangement having an exterior facing surface, a tank facing surface and a central tunnel traversing therebetween along a vertical axis thereof,
b. a fluid drawing module fitted within the central tunnel in a fluid tight manner and having a fluid inlet portion protruding vertically from the tank facing surface and a fluid outlet portion protruding vertically from the exterior facing surface, said fluid inlet portion being configured to be received within the inner container and operative to allow cryogenic fluid flow from the inner container towards the fluid outlet portion; and
c. at least one fluid dispensing member in selective fluid communication with the fluid outlet portion, operative to selectively enable cryogenic fluid flow out to the exterior of the tank connector apparatus.

The second aspect can include at least the embodiments listed below.

30. A tank connector apparatus for connecting a cryogenic fluid tank comprising a neck and an inner container having a bottom, a top constituted by the neck and sidewalls extending therebetween, to a cryogenic fluid delivery system comprising a cryogenic liquid inlet, comprising:
a. a tank attachment arrangement configured to be fitted about the neck of the cryogenic fluid tank in a fluid-tight manner, said tank attachment arrangement having an exterior facing surface, a tank facing surface and a central tunnel traversing therebetween along a vertical axis thereof,
b. a fluid drawing module fitted within the central tunnel in a fluid tight manner and having a fluid inlet portion protruding vertically from the tank facing surface in a direction away from the exterior facing surface and a fluid outlet portion protruding vertically from the exterior facing surface in a direction away from the tank facing surface, said fluid inlet portion being configured to be received within the inner container and operative to allow cryogenic fluid flow from the inner container towards the fluid outlet portion; and
c. at least one fluid dispensing member in selective fluid communication with the fluid outlet portion, operative to selectively enable cryogenic fluid flow out to the exterior of the tank connector apparatus.

31. The tank connector apparatus of embodiment 30, wherein the at least one fluid dispensing member comprises a gas dispensing member configured to selectively dispense cryogenic gas to the exterior of the tank connector apparatus and the fluid drawing module comprises a gas drawing member operative to allow cryogenic gas to flow from the inner container towards the gas dispensing member.

32. The tank connector apparatus of embodiment 30 or 31, wherein the at least one fluid dispensing member comprises a liquid dispensing member configured to selectively dispense cryogenic liquid to the cryogenic liquid inlet of the cryogenic fluid delivery system, and the fluid drawing module comprises a liquid drawing member operative to allow cryogenic liquid to flow from the inner container towards the liquid dispensing member.

33. The tank connector apparatus of any one of embodiments 30 to 32, wherein the liquid drawing member comprises a liquid inlet portion and the gas drawing member comprises a gas inlet portion, both constituting said fluid inlet portion, wherein the liquid inlet portion protrudes to a greater distance from the tank facing surface than the gas inlet portion.

34. The tank connector apparatus of embodiment 32, wherein the liquid drawing member is in the form of a pipe having a first diameter, the fluid drawings module further comprising a sleeve surrounding said liquid drawing member and having a second diameter greater than the first diameter so that an annular space is formed therebetween, constituting the gas drawing member.

35. The tank connector apparatus of embodiment 33 or 34, wherein the liquid dispensing member comprising an engaging member configured to fitably receive therein, in a liquid-tight manner, a corresponding engaging member of the cryogenic fluid delivery system so as to enable fluid communication therebetween.

36. The tank connector apparatus of embodiment 35, wherein the engaging member comprises a liquid flow arresting mechanism configured to prevent liquid flow through the engaging member when the corresponding engaging member is not fitably received therein.

37. The tank connector apparatus of embodiment 35 or 36, wherein the engaging member of the plug portion is constituted by a socket having a certain cross-section and is configured to snuggly receive a corresponding engaging member of the same cross-section.

38. the tank connector apparatus of any one of embodiments 30 to 37, wherein the tank attachment arrangement is formed as a hollow cap-like body being configured to tightly fit onto an external surface of the neck portion of the cryogenic fluid tank, and the tank facing surface comprises at least one aperture forming a fluid passage between the internal container of the cryogenic fluid tank and the hollow cap-like body.

39. the tank connector apparatus of embodiment 38, wherein the cap-like body comprises a pressure gauge, a filling tube having a one-way inlet and a pressure relief valve extending through the sidewalls and in fluid communication with the hollow space in the hollow cap-like body.

40. The tank connector apparatus of embodiment 37 or 38, wherein the tank connector apparatus further comprises a clamp element configured to be dressed on both of the cap-like body and the neck of the cryogenic fluid tank, and is configured with a loose state, in which the tank connector apparatus is enabled to be dressed and removed from the neck portion, and a tight state, in which the clamp element presses a portion of the cap-like body against the neck portion forming a fluid-tight attachment therebetween.

41. The tank connector apparatus of any one of embodiments 30-37, wherein the tank attachment arrangement comprises an extendable body being transitionable between a regular state, in which it is suitable to be inserted into the neck portion of the cryogenic fluid tank, and an extendable state, in which it is operable to be tightly fitted within the neck portion of the cryogenic fluid tank.

42. The tank connector apparatus of embodiment 41, wherein the extendable body is configured to transition from the regular state to the extendable state by a tightening arrangement having an upper portion positioned adjacently above the exterior facing surface and a lower portion positioned adjacently below the tank facing surface, wherein the tightening operable to reduce and increase the distance between the upper portion and the lower portion to transition the extendable body between its regular and extendable states.

43. The tank connector apparatus of embodiment 41 or 42, wherein the central tunnel is formed from a rigid material and the extendable body is formed as a sleeve around the central tunnel.

44. The tank connector apparatus of embodiment 43, wherein the diameter of the sleeve remains the same in both the regular and the extendable states of the extendable body, wherein in the regular state, the sleeve and the central tunnel forms an annular space therebetween, and in the extendable state, the sleeve is tightly pressed, in a fluid tight manner, against the central tunnel.

45. The tank connector apparatus of any one of embodiments 41 to 44, wherein in the regular state the extendable body is configured with a first diameter and in the extendable state, the extendable body is configured with a second dimeter larger than the first diameter.

46. The tank connector apparatus of any one of embodiments 41 to 44, wherein in the regular state the extendable body is configured with a first cross-sectional surface area and in the extendable state, the extendable body is configured with a second cross-sectional surface area larger than the first cross-sectional surface area.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1 is a perspective view of a cryogenic air conditioning device, according to an example of the presently disclosed subject matter;

FIG. 2 is a perspective view of a cryogenic fluid delivery system attached to a cryogenic fluid tank, according to an example of the presently disclosed subject matter;

FIG. 3 is a perspective view of a liquid receiving portion of the cryogenic fluid delivery system as seen in FIG. 2;

FIG. 4A is a perspective view of a boiling chamber of the cryogenic fluid delivery system as seen in FIG. 2, having transparent sidewalls for clarification purposes;

FIG. 4B is a cross-sectional view of the enlarged portion of area 4B in the boiling chamber of FIG. 4A, taken along the plane A-A, having a flow arresting member in a permitting state;

FIG. 4C is the same as FIG. 4B, with the flow arresting member in an arrested state;

FIG. 5A is an exemplary embodiment illustrating a cross-sectional view of the enlarged portion of area 4B in the boiling chamber of FIG. 4A, taken along the plane A-A, having an insulating mechanism in a wrapped state;

FIG. 5B is the same as FIG. 5A, with the insulating mechanism at a remote state;
an insulating mechanism in a folded state;

FIG. 6A is a perspective view of a gas saving module attached to a vaporizing module, according to an example of the presently disclosed subject matter;

FIG. 6B is a perspective view of the enlarged portion of area 6B in the vaporizer module of FIG. 6A, taken along inside a neck of a cryogenic air conditioning device having a cryogenic fluid delivery system, in which a cryogenic valve is opened, and the convector is turned off,

FIG. 6C is a perspective view of the enlarged portion of area 6B in the vaporizer module of FIG. 6A, taken along inside a neck of a cryogenic air conditioning device having a cryogenic fluid delivery system, in which a cryogenic valve is closed, and the convector is turned on;

FIG. 7A is a perspective view of a cryogenic fluid tank known in the art;

FIG. 7B is a cross-sectional view of the cryogenic fluid tank of FIG. 7A, taken along the plane B-B;

FIG. 8A is a perspective view of a tank connector apparatus attached to a cryogenic fluid tank and a system connecting portion attached thereto, according to an example of the presently disclosed subject matter;

FIG. 8B is a cross-sectional view of the cryogenic fluid tank of FIG. 7A, with the tank connector apparatus of FIG. 8A attached thereto;

FIG. 9A is a partially exploded view of the tank connector apparatus and the system connecting portion shown in FIG. 8A;

FIG. 9B is a cross-sectional view of the tank connector apparatus and the system connecting portion attached thereto of FIG. 8A, taken along the plane C-C;

FIG. 10A is a perspective view of a tank connector apparatus attached to a cryogenic fluid tank, according to another example of the presently disclosed subject matter; and

FIG. 10B is a cross-sectional view of the tank connector apparatus and the system connecting portion attached thereto of FIG. 8A, taken along a central vertical plane.

FIG. 10C is a cross-sectional view of the tank connector apparatus and the system connecting portion attached thereto of FIG. 8A, taken along the plane D-D of FIG. 10A.

### DETAILED DESCRIPTION OF EMBODIMENTS

One example of an cryogenic air conditioning device (hereinafter, ‘the device’), according to the presently disclosed subject matter, is configured to operate as an alfresco stand-alone cooling unit, allowing release of a cryogenic fluid to its close proximity.

In general, the device can comprise a housing having a hollow interior and a cryogenic fluid delivery system located within the housing and configured to be connected to a cryogenic fluid tank. The cryogenic fluid delivery system can be configured to enable flow of cryogenic liquid into the system from a first portion, allow received liquid cryogenic fluid to boil into gaseous cryogenic fluid, and to facilitate release of the gaseous cryogenic fluid to the exterior of the system at a different portion thereof. In some cases, the cryogenic fluid tank can be positioned in the vicinity of the device, forming a single portable device. In other cases, the cryogenic fluid tank can be positioned in a remote location, and be connected to one or more devices, in a detachable fluid-tight connection, via one or more tubing elements.

The device can be configured to be used with a cryogenic fluid tank, which can be either integrated within the housing, or be compatible therewith. In further embodiments of the presently disclosed subject matter, the cryogenic fluid tank can be configured with a tank connector apparatus attached thereto, configured to enable quick and safe removal and connection of tanks to the device, as will be elaborated further on.

One of the advantages of using cryogenic fluids for cooling are their liquid-to-gas expansion ratio. Some cryogenic fluids have a liquid-to-gas expansion ratio larger than 1:650 (at 20° Celsius), and for example, one liter of liquid nitrogen can provide about 700 liters of gas, which can be released to the exterior of the device at a relatively low temperature, and be used to reduce the temperature of the immediate surrounding of the device.

The device can be configured to be operated outdoors in an ambient manner. The device can also be configured to be operated without being connected to the power grid (i.e. can be operated by a small portable power source), and in further cases without being plugged to any power source. The device can do so by absorbing heat from the environment, which is sufficient to induce boiling of cryogenic fluids within the device. For that purpose, the device can have a hollow housing defining an inner space that can be configured to accommodate the cryogenic fluid delivery system while providing or preventing insulation therefrom, in order to allow sufficient heat transfer between the system and the environment. By working in an ambient manner, the device can be configured to be mobile, enabling it to be maneuvered from one place to another easily, in a similar manner to gas operated patio heater. In other examples of the presently disclosed subject matter, the device can comprise at least one element that utilizes electricity. In such examples, the device can comprise a heating apparatus for expediting heat absorption by the system or a cryogenic solenoid valve for assisting regulation of cryogenic fluid flow in the device.

The housing can comprise a tank receiving portion configured to accommodate a cryogenic fluid tank and enable insertion and removal of the tank therefrom, for example, for replenishment purposes. The hollow body of the housing can comprise a thin external shell defining internal space, where the external shell can be adapted to enable, at least in some portions thereof, sufficient heat transfer with the exterior of the device. For that purpose, at least a portion of the housing can be formed from a material having high heat conductivity properties, such as Aluminum, Polycarbonate and polypropylene or ABS, and can be formed with a thickness of about 1-4 mm (depending on the type of material used). In some cases, some portions of the housing can be narrower than other to reduce the volume of air in the internal space that separates the cryogenic fluid delivery system from the external shell of the housing. In some cases, some portions of the external shell can be thinner or thicker than others.

The tank receiving portion of the housing can comprise weights sufficient to stabilize itself. In other cases, the housing can be relatively lightweight where sufficient stability can be provided by the tank provided within the housing. In some cases, the tank receiving portion can be configured with a scale at its bottom surface, onto which a cryogenic fluid tank can be positioned for measuring the amount of cryogenic fluid stored therein. The tank receiving portion can further comprise a retractable cart, either integrated therein, or integrable therewith, onto which the cryogenic fluid tank can be positioned.

The housing can comprise a dispensing portion, through which cryogenic gas is release to the exterior of the device at an upper portion thereof and being connected to the tank receiving portion by an elongated neck portion.

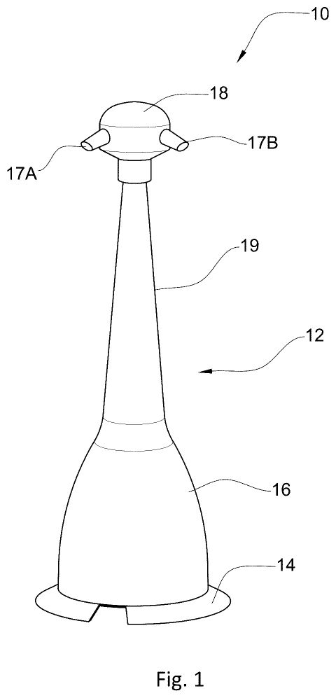

With reference to FIG. 1, the device of the present example designated as 10, has a housing 12 and a base 14, which may be separated from or integral with the housing 12. The housing 12 comprises a tank receiving portion 16 at a bottom portion thereof, configured to receive and house a cryogenic fluid tank (not shown) therein, a dispensing portion 18 at a top portion thereof, and an elongated neck 19 interconnecting the tank receiving portion 16 and the dispensing portion 18.

The tank receiving portion 16 can comprise an opening (not shown) having a selectively removable hatch that provides access to the internal space within the housing 12. The opening and hatch are dimensioned for receiving cryogenic storage tanks of varying sizes, such as 25-50 liter Dewars, and specifically, for 35 Liter Dewars. In some cases, the cryogenic fluid which can be used with the device must be non-toxic and non-flammable cryogenic fluid, such as Nitrogen. In further cases, the cryogenic fluid can be liquidized air (i.e. a mixture of gases imitating the composition of the atmosphere cooled to condensing temperatures), and in such cases, the device can work indoors.

In general, the dispensing portion can be configured to dispense gas up to 360° around it, by having one or more gas outlets positioned therein. The gas outlets can be arranged in equal distances from each other. The one or more gas outlets can be configured with an open state, in which cryogenic fluid gas is dispensed therethrough, and a closed state, in which cryogenic fluid gas is being prevented from being dispensed therethrough. In some cases, the one or more gas outlets can be maneuvered to change their angle with respect to the housing for increasing or decreasing the angle in which the gas is dispensed.

In the present example, the dispensing portion 18 is positioned at the top of the device 10, and comprises three gas outlets 17A, 17B, (the third is not shown), each of which is positioned 120 degrees from the other two about the device, in order to form a cooled sphere about the device.

In general, the dispensing portion can be positioned, at least in operation of the device, between 0.5-3 meters above the tank receiving portion. For that purpose, the neck can be configured with an elongation mechanism, enable it to elongate and shorten, thereby increasing and decreasing the distance of dispensing portion from the tank receiving portion. In some cases, dispensing member can comprise at least one directing element for each gas outlet for directing gas released therefrom. In further examples of the presently disclosed subject matter, the one or more gas outlets can be positioned along the neck of the housing.

In the present example, the elongated neck 19 is hollow, and is configured with a footprint substantially smaller than the tank receiving portion 16 and the dispensing portion 18. The footprint of the neck is configured to enable accommodation of the cryogenic fluid delivery system that provides a conduit for the cryogenic fluid delivery system to couple the cryogenic fluid tank to the dispensing portion 18. While illustrated with a circular cross-section, the elongated neck may take a variety of forms, for example an oval cross-section or a hexagonal or octagonal cross-section.

In general, the cryogenic fluid delivery system can have a tank engaging member at one end thereof, configured to receive liquid cryogenic fluid and at least one dispensing member at the other end thereof, configured to dispense gaseous cryogenic fluid therefrom. The tank engaging member can be configured to be removably attached, in a fluid-tight manner, to the cryogenic fluid tank and to selectively allow cryogenic fluid flow into the system. The cryogenic fluid flow from the cryogenic fluid tank into the system can occur naturally, solely by the internal forces acting inside the tank by the vaporization of the cryogenic fluid therein. In other cases, external means can be used to apply forces onto the fluid within the tank to facilitate liquid cryogenic fluid out from the tank.

The at least one dispensing member can be configured to be held, at least in operation of the system, at an elevated position relative to the tank engaging member and to dispense gaseous cryogenic fluid out to an exterior of the system, i.e. to and through the dispensing member of the housing.

The cryogenic fluid delivery system further comprising a vaporizer module, which fluidly connects the tank engaging member and the dispensing member, in a gas tight manner. For example, the tank engaging member and the dispensing member can be connected by tubing members that are configured to be used with cryogenic fluids. To enable the received liquid cryogenic fluid to turn into gaseous cryogenic fluid, the vaporizer module can comprise a boiling member that is configured to allow liquid cryogenic fluid received therein to boil and vaporize into unpressurized gaseous cryogenic fluid, which is facilitated therefrom to the dispensing member.

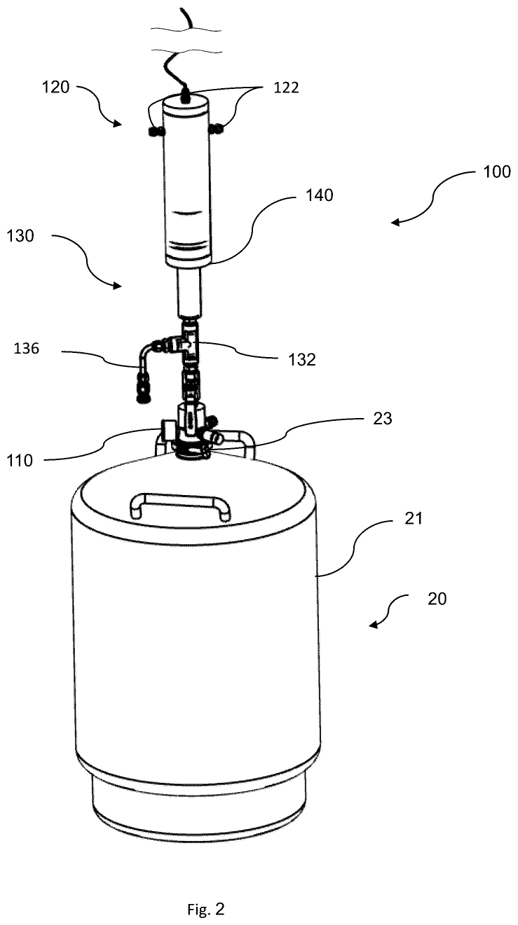

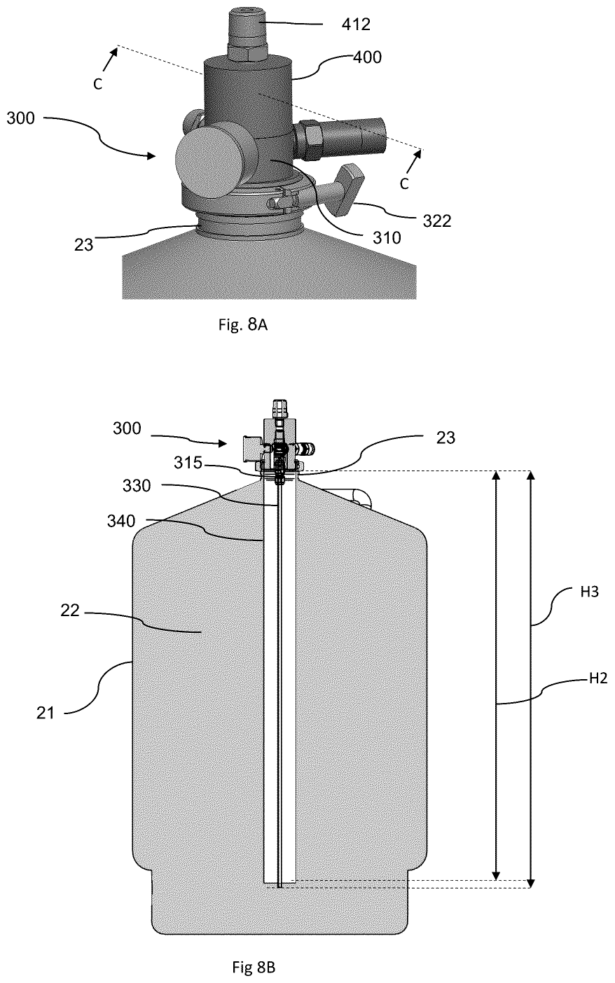

The cryogenic fluid delivery system 100 of the present example is best seen in FIGS. 2 to 5B, and comprises a tank engaging member 110, a dispensing member 120, and a vaporizer module 130 fluidly connecting the tank engaging member 110 and the dispensing member 120. The tank engaging member 110 is configured to enable fluid-tight connection to the cryogenic fluid tank 20, so as to enable fluid communication between the cryogenic fluid tank 20 and the cryogenic fluid delivery system 100. In some cases, the tank engaging member 110 can be configured to be connected to a tank connector apparatus fitted about the neck of the cryogenic fluid tank, as will be discussed further on relating to FIGS. 8A-10C.

In general, the dispensing member of the cryogenic fluid delivery system can be configured to receive and dispense cryogenic gas from the vaporizer module to the exterior thereof. In some cases, the dispensing arrangement can be configured to provide continues stream of gas, while in other cases, it can be configured to provide bursts of gas in varying intensity.

The dispensing member 120 is configured to receive gaseous cryogenic fluid from the vaporizer module 130 and to facilitate it, in a gas tight manner, towards and out from the dispensing portion 18 of the housing 12. In the present example, the dispensing member 120 is constituted by at least one outlet 122, configured to enable the gaseous cryogenic fluid to flow, in about atmospheric pressure, from the boiling chamber 140 to at least one gas outlet 17A and 17B of the dispensing portion 18.

In general, the vaporizer module can be formed as a gas-tight tubing system configured to enable cryogenic fluid flow therein, from the tank engaging member to the dispensing member. For that purpose, the vaporizer module can be formed from materials suitable to work with cryogenic fluids. It is emphasized that the system can operate solely by the travel of the cryogenic fluid inside the vaporizer module occurred solely by the pressure generated by the ambient vaporization of the cryogenic fluid within the tank.

The vaporizer module can comprise a liquid receiving portion, and a gas releasing portion. The liquid receiving portion can comprise a safety release valve having a pressure relief valve, which is configured to enable cryogenic fluid to be released from the liquid receiving portion when pressure within to rise above a certain threshold.

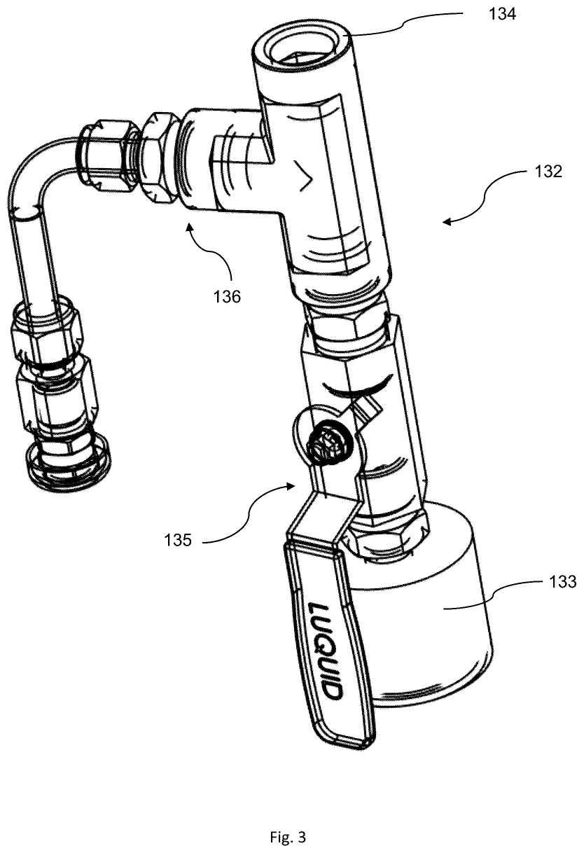

The liquid receiving portion of vaporizer module 130 of the present example, designated 132, shown in FIG. 3 comprises a system connecting portion 133, suitable to connect to a cryogenic fluid tank 20 as will be elaborated below, a liquid outlet 134, a stopcock 135 configured to enable a user to manually arrest fluid flow to the system, a pressure relief valve 136 configured to be opened, so as to direct liquid cryogenic fluid from the liquid receiving portion 132 to the exterior of the system, in case the pressure in the liquid receiving portion 132 is dangerously high, i.e., above 22 PSI. The gas releasing portion of the present example is constituted by the dispensing member 120 of the system.

In general, the vaporizer module can be configured with a boiling chamber, in which liquid cryogenic fluid can boil, in a controlled manner, and turn into gaseous cryogenic fluid. The boiling chamber can be configured with a liquid receiving portion, configured to enable liquid cryogenic fluid to accumulate therein and a gas releasing portion configured to allow liquid cryogenic fluid accumulated therein to boil into a gaseous cryogenic fluid, and to facilitate delivery thereof, in an unpressurized manner, towards the dispensing member. The term “unpressurized manner” used herein, means that the gaseous cryogenic fluid can flow through the dispensing member of the system and out of the dispensing portion of the housing at least by the pressure generated solely by the boiling occurring in the gas releasing portion of the boiling chamber.

The boiling chamber can comprise a liquid receiving container and a gas dispensing container in fluid communication with each other. The liquid receiving container can constitute the liquid receiving portion of the boiling chamber and be in fluid communication with the liquid receiving portion at one portion thereof, and in fluid communication with the gas dispensing container at a different portion thereof. The liquid receiving container can be configured to receive and accumulate liquid cryogenic fluid therein in a manner that mitigate boiling thereof within the liquid receiving container.

The gas dispensing container can constitute the gas releasing portion and be in fluid communication with the receiving container, so as to receive liquid cryogenic fluid therefrom, and in fluid communication with the dispensing member, so as to enable gaseous cryogenic gas to be dispensed therefrom. The gas dispensing container can be configured to allow cryogenic liquid positioned therein to boil into its gaseous form, in a controlled manner. The gas dispensing container can comprise sidewalls that can be configured with dimensions suitable to be positioned and/or fitted in close proximity to the external envelope of the housing, and more specifically, to the elongated neck thereof, in order to enable ambient heat transfer between the exterior of the housing and the internal space of the container.

The liquid receiving container and the gas dispensing container can be connected to each other in a way that liquids are starting to flow into the gas dispensing container only when the liquid receiving container is about full. In one example of the presently disclosed subject matter, the gas dispensing container can be positioned on top of the liquid receiving container, and more specifically, at least a portion of the ceiling of the liquid receiving container constitutes at least a portion of the floor of the gas dispensing container. In other examples, the liquid receiving container and the gas dispensing container can be fluidly connected by fluid-tight piping elements.

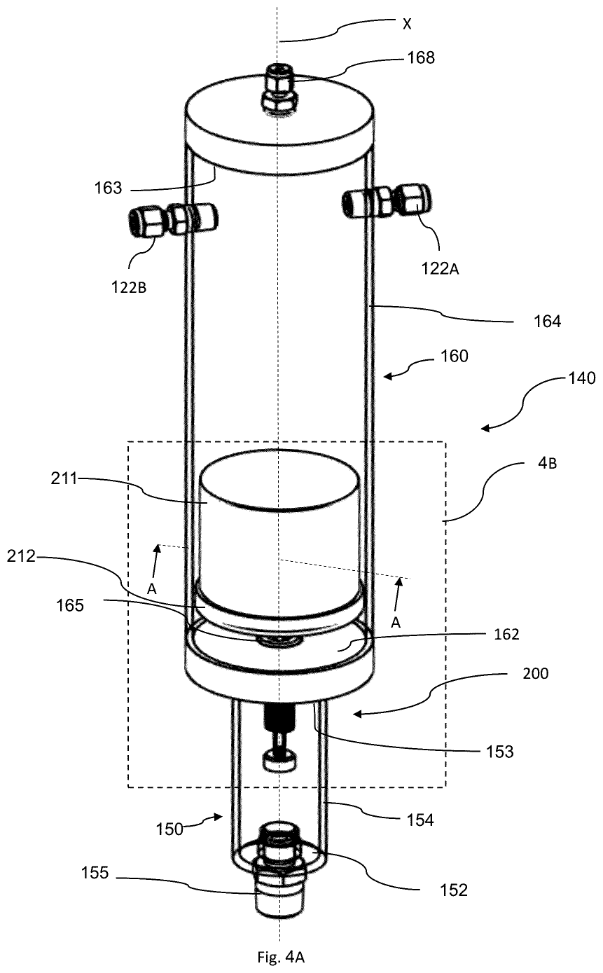

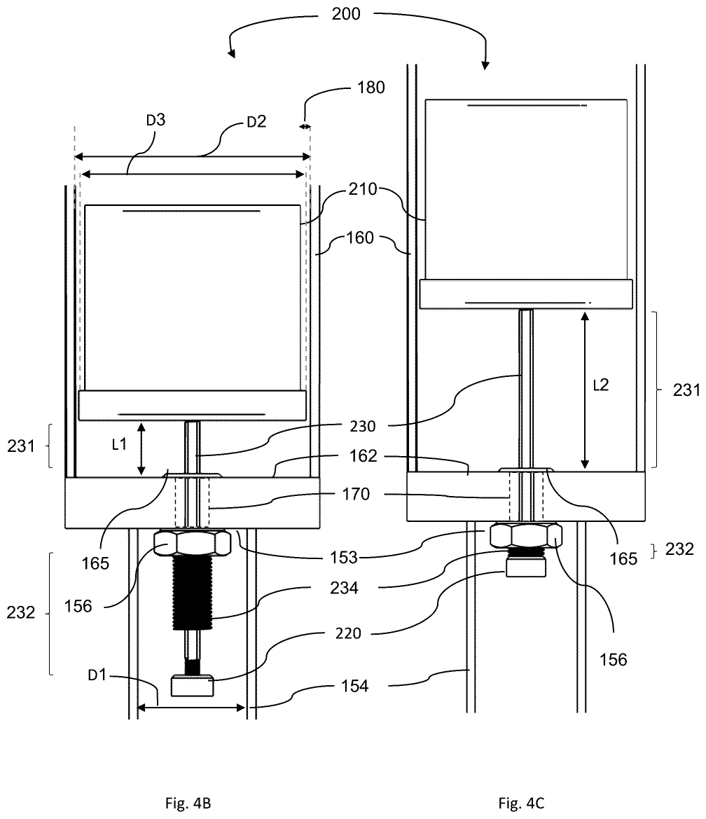

As shown in FIGS. 2 and 4A-4B, the vaporizer module 130 comprises a boiling chamber 140, configured to allowed liquid cryogenic fluid positioned therein to boil into gaseous cryogenic fluid. In the present example, the boiling chamber 140 is configured to be positioned within the elongated neck 19 of the housing 12. In this example, the diameter thereof is slightly smaller than the diameter of the elongated neck 19. The boiling chamber 140 comprises a liquid receiving container 150, and a gas dispensing container 160 fluidly connected to the liquid receiving container 150 in a fluid-tight manner.

The liquid receiving container 150 is formed as a cylinder defining a central axis X passing vertically therethrough and comprises a bottom partition 152, a top partition 153 and sidewalls 154 extending therebetween and having a first internal diameter D1. A liquid inlet 155 is formed in the bottom partition 152, through which liquid cryogenic fluid is enabled to enter from the tank via the liquid receiving portion 132, and a liquid outlet 156 is formed at the top partition 153 thereof. Both the liquid inlet 155 and the liquid outlet 156 are concentric with the central axis X. The gas dispensing container 160 is also formed as a cylinder and comprising a bottom partition 162, which constitutes the upper surface of the top partition 153 of the liquid receiving container 150, a top partition 163 and sidewalls 164 extending therebetween and having a second internal diameter D2, larger than D1. The bottom partition 162 comprises a liquid inlet 165, fluidly connected to the liquid outlet 156, and the top partition 163 comprises a gas outlet 122A and 122B together constituting the dispensing member 120. The liquid inlet 165 is also concentric with the central axis X and forms a connecting channel 170 with the liquid outlet 156 of the liquid receiving container 150. The gas dispensing container 160 comprises at least one connector 168, which is configured to enable integration of an add-on to the system.

In general, the boiling chamber can further comprise an arresting arrangement, configured to selectively arrest the fluid communication between the liquid receiving container and the gas dispensing container when a predetermined amount of liquid is positioned within the gas dispensing tank. As such, when the liquid receiving container is filled to a certain extent that liquid cryogenic fluid enters the gas dispensing container, and when enough cryogenic liquid enters, the arresting arrangement arrests the fluid path. Thus, the liquid cryogenic fluid within the container absorb latent heat and vaporizes into gaseous form. Then, since liquid-to-gas expansion ratio is larger for cryogenic gases, the gaseous cryogenic fluid self-pressurizes itself out from the gas outlet of the gas dispensing chamber, through the dispensing member and out of the system.

The arresting arrangement can comprise a measuring element and an arresting element. The measuring element is configured to measure the amount of liquid in the gas dispensing container, and actuate the arresting element when a predetermined amount of liquid is measured, and the arresting element is configured to arrest the fluid communication between the liquid receiving container and the gas dispensing container upon actuation thereof by the measuring element.

As shown in FIGS. 4A-4C, the boiling chamber 140 further comprises a flow arresting member 200 configured with a permitting state, in which fluid can flow into the gas dispensing container 160, and an arresting state, in which fluid is prevented from flowing into the gas dispensing container 160, so as to enable liquid cryogenic fluid positioned therein to boil. The flow arresting member 200 comprising a float 210 positioned in the gas dispensing container 160 and a plug member 220 positioned in the liquid receiving container 150. The float 210 is configured to rise with the liquid level in the gas dispensing container 160, and thus constitutes a measurement element for measuring the amount of liquid in the gas dispensing container. The plug member 220 is configured to fit onto the liquid outlet 156 of the liquid receiving container so as to selectively arrest liquid flow therefrom towards the gas dispensing container 160 when actuated by the float 210.

The float 210 is configured with dimensions and formed from a material suitable for work with cryogenic fluids while allowing it to float in the type of cryogenic fluid stored in the cryogenic fluid tank. In cases where the cryogenic fluid is nitrogen, the float can be formed of engineering thermoplastics such as Polyoxymethylene. The float 210 is configured with a slightly smaller but similar shape as the gas dispensing container 160 for preventing the float 210 from being angled to the sidewalls 164 of the gas dispensing container 160, while forming a gap 180 between the float 210 to sidewalls 164 through which gaseous cryogenic fluid is enabled to pass. The float 210 comprises a third internal diameter D3, smaller than the second internal diameter D2 of the gas dispensing container 160 and larger than the first internal diameter D1. The distance D2−D3 is configured to be sufficient to enable vaporization of liquid cryogenic fluid located below the float 210, and to enable the vaporized gaseous cryogenic fluid to be facilitated towards the dispensing member 120. In the present example, the float 210 is formed from a hollow body 211 having a cap 212 tightly fitted thereon. In general, the measuring element and the arresting element can be constituted by two distinct elements, being in electrical communication, wither wired or wireless, with each other. For example, the float and the plug can be in wireless communication with each other and when the float reaches a certain distance from the bottom partition of the gas dispensing container, it can signal the plug to block the liquid outlet. In some cases, the measuring element and the arresting element can be physically connected to form a single element, where the arresting element can be located in the liquid receiving container, and the measuring element can be location in the gas dispensing container, while having a connecting member connecting them via the connecting channel. In some cases, the length of the connecting element can be changed in order to bring the float and the plug closer to each other, or more distant from each other.

In the present invention, the float 210 and the plug member 220 are connected via a connecting member 230 having a top end connected to the float 210, and a bottom end constituted by the plug member 220. The connecting member 230 extends along the vertical axis X through the connecting channel 170 and having a gas-dispensing segment 231 positioned within the gas-dispensing chamber and a liquid receiving segment 232, positioned within the liquid receiving container 150. In the permitting state, the gas-dispensing segment 231 is configured with a length L1, and in the arresting state, the gas-dispensing segment 231 is configured with a length L2 larger than L1, where the length L2−L1 determines distance which the float should rise in order for the plug to reach and block the liquid outlet 156. In the present example, the liquid receiving segment 232 of the connecting member 230 is configured with a spring 234 element threaded thereon, which is configured to apply an opposite force to the lift force the float applies on the connecting member 230 in the arrested state, in order to facilitate smooth operation and transition between the states of the flow arresting member 200. In other examples, the float 210 is configured with enough weight to provide sufficient gravitational force to in order to facilitate smooth operation and transition between the states.

In accordance with an example of the presently disclosed subject matter, the device can comprise an insulating arrangement about any of the vaporizing module portions. Specifically, the device can comprise an insulating arrangement about the boiling chamber configured to selectively provide an insulating layer between the boiling chamber and the external shell of the device. The insulating arrangement can be configured with a retracted state, in which the boiling chamber sidewalls are in close proximity to the external shell of the housing and only air separates the boiling chamber therefrom. The insulating arrangement can also be configured with a deployed state, in which a retractable layer surrounds at least a portion of the boiling chamber. The retractable layer can be configured with heat insulating properties, for slowing the boiling rate of the cryogenic fluid within the boiling chamber, resulting with less gaseous cryogenic fluid dispensed through the device. In other cases, the retractable layer can be configured with heat conducting properties, for accelerating the boiling rate of the cryogenic fluid within the boiling chamber, resulting with more gaseous cryogenic fluid dispensed through the device.

The insulating arrangement can comprise a deployment mechanism configured to selectively deploy and retract the retractable layer about any portion of the boiling chamber. The deployment mechanism can be configured to deploy the retractable layer to a desirable extent between full deployment, in which the retractable layer completely surrounds at least the gas dispensing chamber, and no deployment, in which the retractable layer can be either fully retracted within the deployment mechanism, or be distanced from the gas dispensing chamber. In some cases, the deployment mechanism can be constituted by scrolling mechanism, or by a sleeve capable to be vertically maneuvered so as to be dressed and removed from the gas dispensing chamber.

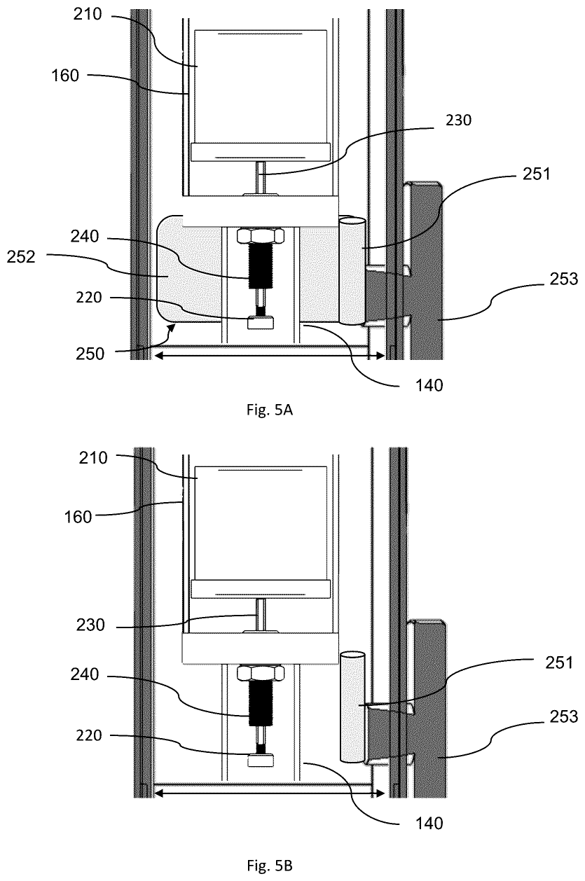

In the present example, the device further comprises an insulating arrangement 250, which in FIG. 5A is in a deployed state, and in FIG. 5B is in a retracted state. The insulating arrangement 250 comprises a maneuvering mechanism 251 and a retractable layer 252 having a cylinder shape and dimensioned to fit between the liquid receiving container 150 and the external shell of the housing 12 so as to encompass the entire liquid receiving container 150. The maneuvering mechanism 251 of the present example is demonstrated as a scrolling mechanism, in which the one side of the retractable layer 252 is fixedly connected, and is configured to accommodate about the entirety of the retractable layer 252 in the deployed state, and to deploy about the entirety of the retractable layer 252 in the deployed state. The maneuvering mechanism 251 of the present invention is operated manually, without requiring electricity by actuation handle 253, enabling a user to determine the extent which the retractable layer 252 encompasses the gas dispensing container 160.

In general, the cryogenic fluid delivery system can comprise a cryogenic gas saving module that can be configured to extend the amount of time each cryogenic fluid tank can be used. The cryogenic gas saving module is transitionable between a accumulating state, in which the boiling chamber can accumulate cold in the form of ice and/or cold air thereabout, resulting from the intense cold inside the boiling chamber, and a dispending state, in which the cooling is being performed by convection means. The cryogenic gas saving module can be configured to utilize that accumulated cold in order to cool the surroundings without using cryogenic fluid, which means that the cryogenic fluid flow can be arrested while the cryogenic gas saving module operates. The cryogenic gas saving module can be operated by actuating at least one air flow generator that generates an air flow that would be cooled by the cold within the device and convey it to the external surrounding of the device, while using a cryogenic valve in order reduce and/or prevent cryogenic fluid flow towards the boiling chamber. Convection of the accumulated cold may also elevate the temperature of the boiling chamber and its immediate surroundings, in a range of temperatures that are preferable to the smooth operation of the boiling chamber.

The cryogenic gas saving module can be configured to be operated by electricity which can be derived either from an external power grid, a self generated electricity or from a battery constituting a portion of the system. In some cases, power can be generated during operation of the boiling chamber and be discharged during activation of the cryogenic gas saving module. In cases where a battery can be used to supply power to the cryogenic gas saving module, the system can comprise two battery slots, configured to enable one battery to supply power to the module while the other battery is enabled to be charged externally to the system.

In some cases, the cryogenic gas saving module can be configured with a heat sensor in electronic communication with the cryogenic valve and the convection means. In such cases, when the temperature of the boiling chamber is reduced below a predetermined threshold, the cryogenic gas saving module provide instructions to the cryogenic valve to prevent, or greatly reduce flow from the tank towards the boiling chamber while activating the convention means.

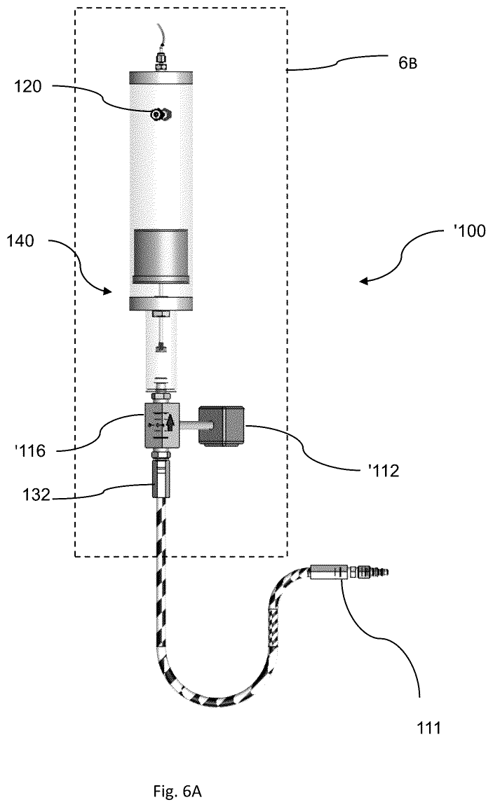

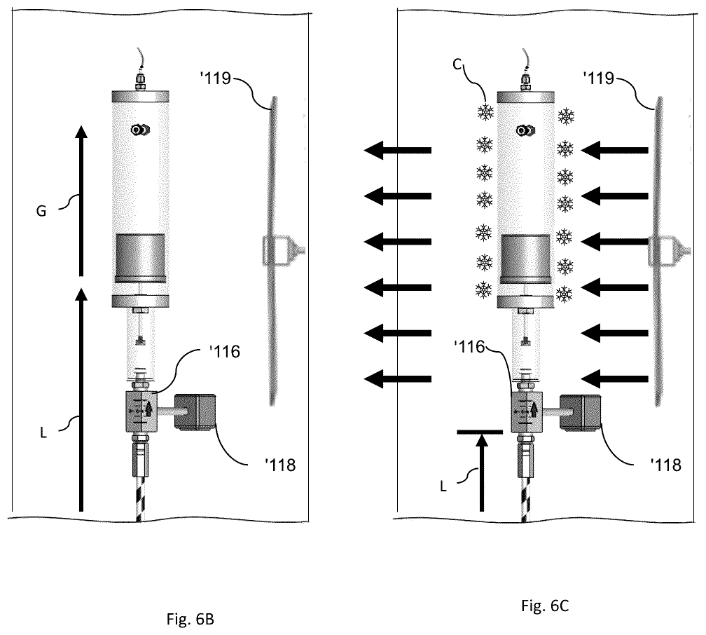

In the present example, shown in FIGS. 6A to 6C, a cryogenic gas saving module 110′ is interconnecting the tank engaging member 110 to the boiling chamber 140 by a cryogenic valve 116′. The cryogenic valve 116′ is connected to a valve engine box 112′, in which there is a motor (not shown) configured to operate the cryogenic valve 116′. At least one convection member 119′ can be positioned adjacent to the boiling chamber, and can be configured to be operated when so as to convey cold from within the air conditioning apparatus to the exterior thereof. A communication module (not shown) is positioned within the valve engine box 112′ and configured to receive information about the amount of cold accumulated about the boiling chamber 140 by a temperature sensor (also not shown) and communicate with the convection means 119′ and motor of the cryogenic valve 116′ accordingly.

As shown in FIG. 6B, the amount of cold (C) accumulated on the boiling chamber 140 is not sufficient to induce sufficient cooling to the exterior of the system, and as such, normal operation of the system 100 occurs, having liquid cryogenic fluid flow towards the boiling chamber (arrow L) and having gaseous cryogenic fluid flow towards the dispensing member (arrow G). In this situation the cryogenic valve 116 is open (normally opened in this case), and the convection means are not operational.

As shown in FIG. 6C, the amount of cold (C) accumulated on the boiling chamber 140 is now sufficient to induce sufficient cooling to the exterior of the system, and as such, the cryogenic gas saving module 110′ being transitioned into the dispending state. In the dispending state liquid cryogenic fluid flow towards the boiling chamber (arrow L) is being arrested (arrow L). In this situation the cryogenic valve 116 is closed, and the convection means 119 are operational so as to covey heat to the exterior of the housing.

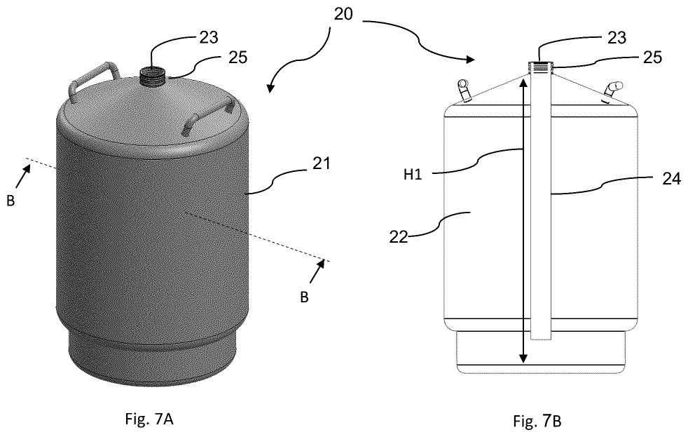

FIGS. 7A and 7B illustrates a typical cryogenic fluid tank, for use with the device of the present invention. The cryogenic fluid tank 20 comprises an outer jacket 21, and an inner fluid-holding vessel 22 which can have an insolating layer therebetween (not shown). The inner fluid-holding vessel 22 forms a neck portion 23 with the outer jacket 21, defining an opening to the inner fluid-holding vessel 22 and formed with an entry tube 24 extending from the neck portion into the inner fluid-holding vessel 22 almost to the bottom thereof.

In accordance with the presently disclosed subject matter, the tank engaging member of the cryogenic fluid delivery system can be configured to be detachably attached, in a fluid-tight manner, to the cryogenic fluid tank in a manner that selectively allow cryogenic fluid flow out of the tank and into the system. For that purpose, the cryogenic fluid tank can be configured with a tank connector apparatus to which the tank engaging member of the cryogenic fluid delivery system can connect to enable attachment and removal of the system from the tank in a fast and convenient manner to a user and without exposing the cryogenic fluid stored within the tank to the environment. The tank connector apparatus can comprise a coupling element configured to fixedly attach the tank connector apparatus to the cryogenic fluid tank.

In general, the tank connector apparatus, which can be configured to be attached, in a fluid tight manner, to the cryogenic fluid tank, can comprise a tank attachment arrangement, which is configured to be fitted about the neck of the tank and a fluid drawing module configured to facilitate flow of fluid cryogenic fluid from the tank, through the body, and to the exterior thereof in a controlled manner. The tank attachment arrangement can comprise a central tunnel traversing along a vertical axis thereof, for enabling fluid to flow therethrough.

In some cases, the fluid drawing module can be fitted within the central tunnel in a fluid tight manner and can have a fluid inlet portion protruding vertically from the tank facing surface in a direction away from the exterior facing and a fluid outlet portion protruding vertically from the exterior facing surface in a direction away from the tank facing surface. The fluid inlet portion can be configured to be received within the inner container and operative to allow cryogenic fluid flow from the inner container towards the fluid outlet portion. The fluid outlet portion can be configured to be in fluid communication with at least one fluid dispensing member operative to selectively enable cryogenic fluid flow out to the exterior of the tank connector apparatus.

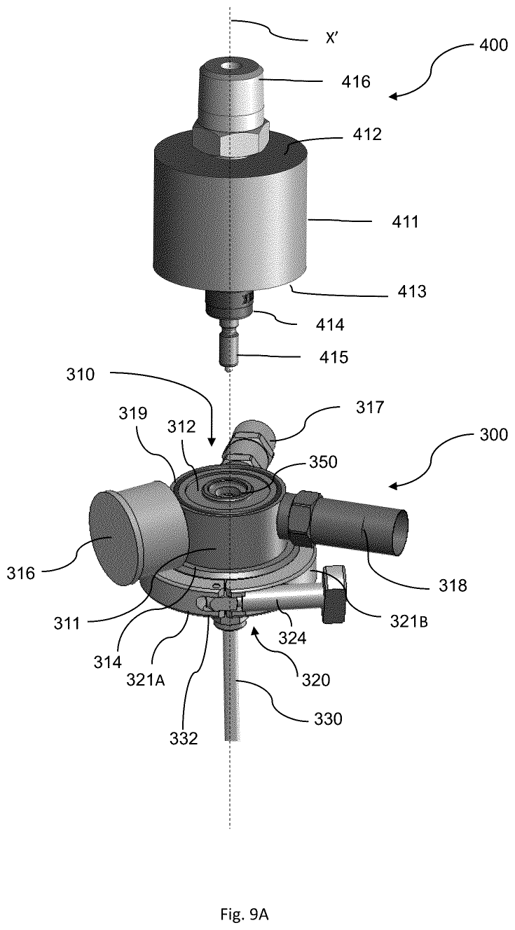

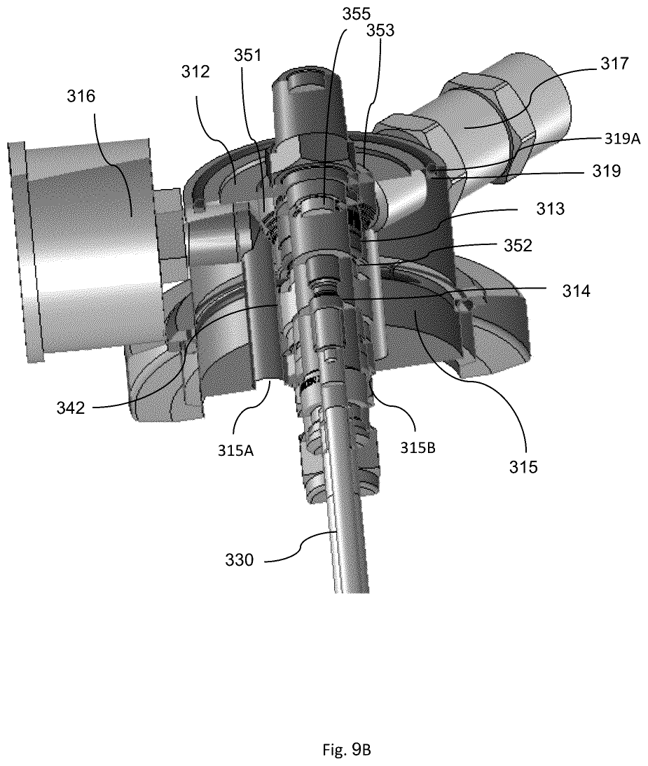

One example of the tank connector apparatus 300 of the presently disclosed subject matter is shown in FIGS. 8A and 8B attached to a cryogenic fluid tank 20, and in FIGS. 9A and 9B with a system connecting portion 400 of the tank engaging member 110. The tank connector apparatus 300 comprises a cap-like body 310 having sidewalls 311 extending between a system facing surface 312 and an opposite tank facing surface 313. The sidewalls 311 are dimensioned to snuggly fit within the neck portion 23. The sidewalls also comprises a skirt 314 protruding laterally outwards from a portion of the sidewalls 311 above the tank facing surface 313, extending to an extent sufficient to be positioned on top of the neck portion 23, whereas the portion of the neck below the skirt 314 defines a neck-fitting portion 315 configured to be snugly fitted in the neck portion 23 when the tank connector apparatus 300 is attached to the cryogenic fluid tank 20. The skirt 314 comprising a bottom surface, having a circumferencing groove (not shown), having a sealing band positioned therein to prevent fluid leakage from the cryogenic fluid tank 20 when the cap-like body 310 is attached thereto.

The cap-like body 310 also comprises a pressure gauge 316, a one way valve 317, and at least one relief valve 318 extending through from the exterior into an internal space formed within the cap-like body 310, and are in fluid communication with the Three gas permitting apertures (two of which 315A and 315B are shown), are formed in the tank facing surface 313 of the cap-like body 310, which is hollow in the present example, and enable fluid communication with the inner fluid-holding vessel 22 when attached to the tank.

In general, the coupling element of the tank connector apparatus can be constituted by an integral portion of the cap like body, such as an extension of the skirt that can be threaded onto the neck portion of the tank. In other cases, the coupling element can be implemented by any attachment means known to the person having ordinary skill in the art. More specifically, the coupling element can have at least a portion thereof configured to be laid against the cap-like body and at least a portion thereof configured to be laid against the neck portion, either from within or from the exterior thereof. The coupling element can be configured with a tightening arrangement operative to increase the attachment of the tank attachment arrangement to the neck portion.

In the present example, the tank connector apparatus 300 comprises a coupling element 320 constituted as a tightening clamp, formed from two semi-circles 321A and 321B, pivotally connected at one end thereof to each other, and having a tightening arrangement 324 at the other end thereof. Each semi-circle of the coupling element 320 is configured with an upper rim protruding laterally inwards from the top end thereof and configured to be dressed onto the skirt 314 of the cap-like body, and a bottom rim protruding laterally inwards from the bottom surface thereof and configured to be laid against a portion of the neck portion of tank, which in the present example is one of a plurality of circumferencing grooves 25 embedded in the neck portion 23, enabling such fitting.

In general, the liquid drawing module can comprise a tank facing portion and an attachment portion. In some examples, the tank facing portion can extend vertically outwards from the tank facing surface, to an extent sufficient to reach about the bottom of the inner fluid-holding vessel, when connected to the tank, in order to enable it to draw liquid even when small amount of cryogenic liquid is present int the tank. In other examples, the tank engaging member of the system can be constituted by a flexible hose and the tank facing portion can be stationary in order to enable easy detachment of the flexible hose from the cryogenic fluid tank, and enable easy attachment thereof since the cryogenic fluid tank can be positioned in a radius instead of a specific spot in order for the flexible hose to reach it.

The attachment portion of the liquid drawing module t can face the exterior of the system facing surface, while being either flush, protruding from, or embedded therein. The attachment portion can comprise a receiving socket configured to fitably receive, in a gas-tight manner, a corresponding engaging member of the cryogenic fluid delivery system. The corresponding engaging member of the cryogenic fluid delivery system can have complementary shape to the receiving socket and the receiving socket can be configured with a flow-arresting mechanism configured to prevent fluid flow therethrough when the corresponding engaging member is not fully engaged therewith.

In the present example, the tank connector apparatus 300 comprises a liquid drawing module t 340 traversing the cap-like body 310 from the system facing surface 312 to the tank facing surface 313 being concentric with a central vertical axis X′. The liquid drawing module t 340 comprises a tank facing portion constituted by a tube 330 extending vertically downwards from the tank facing surface 313 of the cap-like body 310. The tube 330 comprises a height H3 slightly larger than the height H2 of the inner fluid-holding vessel 22, which is sufficient to reach about the bottom thereof in order to enable drawing liquid even when the amount of liquid in the inner fluid-holding vessel 22 is low.

The attachment portion of the liquid drawing module 340 comprises a receiving socket 350 embedded within the system facing surface 312 of the cap-like body 310 having a quick connector (not shown) interconnecting the receiving socket 350 and the tube 330. The receiving socket 350 is configured with inclined sidewalls 351 converging into a bottom aperture 352 leading to the selective connector 355. The top surface of the inclined sidewalls 351 is configured with a guiding rim 353, protruding vertically upwards from the system facing surface 312 to enable guided insertion of a corresponding element into the receiving socket 350. The selective connector 355 of the present example is configured to selectively enable fluid passage therethrough only when a corresponding engaging element is fitted therein.

In general, the tank engaging member of the cryogenic fluid delivery system can be constituted by a system connector portion configured to be form a detachable flow path with the tank connector apparatus 300. The system connecting portion can comprise a connector body having a system side surface and a tank facing surface. The system side surface can be configured with a system connector configured to enable fluid-tight connection to the cryogenic fluid delivery system, and more specifically, to the vaporizer module. The tank facing surface can comprise a corresponding engaging element protruding vertically therefrom and configured to be tightly fitted, in a fluid-tight manner, in the receiving socket of the tank securing portion, and more specifically, to have at least a portion thereof snuggly fitted through the aperture at the bottom of the receiving socket.

In the present example, the tank engaging member of the cryogenic fluid delivery system 100 constitutes comprises a system connecting portion 400 configured to engage with the tank connector apparatus 300. The system connecting portion 400 comprises a body 410 having sidewalls 411 extending between a system facing surface 412 and a tank facing surface 413 having a matching or larger circumference than the system facing surface 312 of the tank connector apparatus 300. To enable fluid-tight connection between the system connecting portion 400 and the tank connector apparatus 300, the system facing surface 312 of the cap-like body 310 comprises a circumferencing recess 319 extending about the circumference thereof and having a sealing band 319A snuggly fitted therein.

The system connecting portion 400 comprises a corresponding engaging element 415 protruding from the tank facing surface 413 and a system connector (not shown) protruding from the system facing surface 412, both extending along and concentric with the central vertical axis X′. The corresponding engaging element 415 comprises a socket matching portion 414, configured with a matching cross section to the receiving socket 350 so as to be snuggly fitted therein, and the corresponding engaging element 415 is configured to match the selective connector 355.

In general, the tank connector apparatus can be configured with an extension mechanism, configured to maneuver between a retracted state, in which the system connecting portion is distanced from the tank engaging member, so as to enable removal of the tank, either together or without the tank engaging member, and a fitted state, in which the system connecting portion is fitted, in a gas tight manner onto the tank engaging member. In some cases, the system connecting portion can constitute the extension mechanism, where in the retracted state, at least the engaging element is distanced from the system connector to a first extent, and in the fitted state, the engaging element is distanced from the system connector to a second extent, greater than the first extent, while still providing fluid-tight passage from the engaging element and out from the system connector.

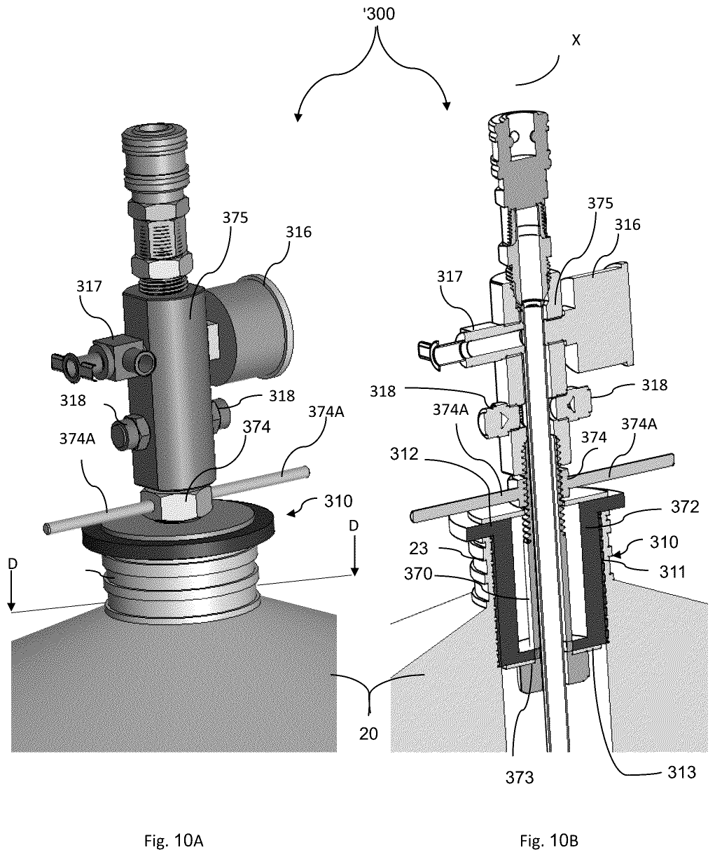

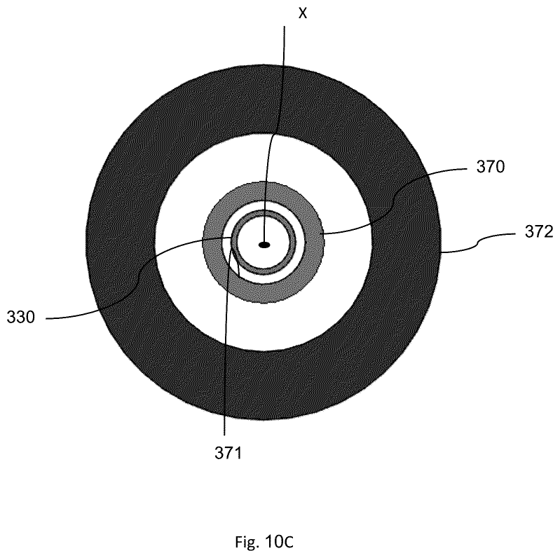

Another example of a tank connector apparatus 300′ of the presently disclosed subject matter is shown in FIGS. 10A to 10C, attached to a cryogenic fluid tank 20. The tank connector apparatus 300 comprises an extendable body 310 having sidewalls 311 extending between a system facing surface 312 and an opposite tank facing surface 313. The sidewalls 311 are dimensioned to snuggly fit within the neck portion 23. The body also comprises a skirt 314 protruding laterally outwards from the system facing surface 312, extending to an extent sufficient to be positioned on top of the neck portion 23.

In general, the tank connector apparatus can be connected to the neck of the cryogenic fluid tank by being tightly fitted, in a fluid-tight manner, in the neck portion. In some cases, the tank connector apparatus can be configured to increase its diameter to press on the internal walls of the neck portion and thereby providing fluid-tight seal. The tank connector apparatus can have a rigid core and a compressible envelope, where the compressible envelope is designed to be fitted onto the rigid core in a manner enabling it to be compressed so as to increase its diameter. In some cases, the portion of the tank connector apparatus 300′ which is intended to be compressed against the sidewalls can be configured with a rigid surface for increasing the friction therebetween.

In the present example, the body comprises a rigid hollow tunnel 370 having interior walls 371, a tank facing portion 370A and an exterior facing portion 370B. The rigid hollow tunnel 370 traversing the body from the system facing surface 312 to the tank facing surface 313 along a vertical axis X thereof, and a compressible external shell 372 held on the rigid hollow tunnel 370 by a bottom nut 373 attached thereto. The extendable body 310 is configured to be transitionable between an regular state, in which it has a first diameter, to a extendable state, in which it has a second diameter larger than the first diameter enabling it to be tightly fitted within the neck portion 23. The body is configured to compressed from the regular state to the extendable state by a tightening nut 374 threaded onto a thread located on the exterior facing portion 370B of the rigid hollow tunnel 370. The tightening nut 374 comprises lateral handles 374A enabling a user to change the state of the body from the regular state to the extendable state.

The tank connector apparatus 300′ further comprises a gas containing portion 375 (or fluid outlet), configured to receive cryogenic gas from the cryogenic fluid tank and to enable release thereof to the exterior of the tank connector apparatus 300′ in a selective manner. The gas containing portion 375 comprises a pressure gauge 316 and a one way valve 317, and at least one relief valve 318 extending from the exterior into an internal space formed within the gas containing portion 375.

The tank connector apparatus 300′ comprises a liquid drawings member 330, constituted by a pipe having a diameter smaller than the diameter of the internal space of the gas containing portion 375. The liquid drawings member 330 comprises a top portion, having an attachment portion protruding from a top surface of the gas containing portion 375, and is identical to the attachment portion of the liquid drawing module t 340. The liquid drawings member 330 also comprises a bottom portion extending vertically away from the tank facing surface 313 of the body 310 and being aligned with the vertical axis thereof. The liquid drawings member 330 and the inner walls 371 of the rigid hollow tunnel 370 are concentric and spaced from each other to their entire length, so as to enable cryogenic gas to flow in that space from the cryogenic fluid tank to the gas containing portion 375 (as shown in FIG. 10C).

1-41. (canceled)

42. A cryogenic fluid delivery system for use with a cryogenic fluid tank, comprising:
a. a tank engaging member configured to be fixedly attached to said cryogenic fluid tank and to selectively allow cryogenic fluid flow out of said tank and into the system,
b. an at least one dispensing member configured to dispense cryogenic fluid to an exterior of the system, and optionally, to be held, at least in operation of the system, at an elevated position relative to the tank engaging member; and
c. a vaporizer module fluidly connected to said tank engaging member and to the at least one dispensing member, and comprising a boiling chamber having a liquid receiving portion configured to receive liquid cryogenic fluid and a gas releasing portion allowing liquid cryogenic fluid positioned therein to boil into a gaseous cryogenic fluid, and to facilitate delivery thereof, in an unpressurized manner, towards the at least one dispensing member, wherein the boiling chamber comprises:
i. a liquid receiving container constituting the liquid receiving portion, comprising a liquid cryogenic fluid inlet in fluid communication with the tank engaging member and a liquid outlet;
ii. a gas releasing container constituting the gas releasing portion, comprising a fluid inlet in fluid communication with the liquid outlet of the liquid receiving container and a gas outlet in fluid communication with the dispensing member; and
iii. a flow arresting member configured to selectively arrest the fluid communication between the liquid receiving container and the gas releasing container when a predetermined amount of liquid is contained within the gas dispensing tank.

43. The cryogenic fluid delivery system of claim 42, wherein the flow arresting member comprises a float member located within the gas releasing container and a plug member located within the liquid receiving container and connected to said float member by a connecting element, wherein said plug member is configured with a shape suitable to plug the liquid outlet of the liquid receiving container.

44. The cryogenic fluid delivery system of claim 43, wherein the liquid receiving container is positioned adjacently below the gas releasing container and the liquid outlet of the liquid receiving container is positioned adjacently below the fluid inlet of the gas releasing container.

45. The cryogenic fluid delivery system of claim 43, wherein the float member is configured with dimensions and density sufficient to allow it to float on cryogenic fluid of the type stored in the cryogenic fluid tank.

46. The cryogenic fluid delivery system of claim 43, wherein the float member is configured with a similar but smaller cross section to the cross section of the gas releasing container.

47. The cryogenic fluid delivery system of claim 42, wherein the cryogenic fluid delivery system is exposed to ambient temperature.

48. The cryogenic fluid delivery system of any one of claim 42, wherein the cryogenic fluid delivery system is at least partly free of thermal insulation from the ambient.

49. The cryogenic fluid delivery system of claim 48, wherein at least a portion of the boiling chamber comprises a boiling-rate control arrangement.

50. The cryogenic fluid delivery system of claim 42, further comprising a pressurizing arrangement configured to controllably exert pressure on the cryogenic fluid within the boiling chamber.

51. The cryogenic fluid delivery system of claim 50, wherein the pressurizing arrangement comprises at least one heating element configured to apply heat, at least indirectly, to the interior of the boiling chamber, and a pressure sensor configured to measure gas pressure within the interior of the boiling chamber.

52. The cryogenic fluid delivery system of claim 50, wherein the pressurizing arrangement is configured to be connected to an independent power source.

53. The cryogenic fluid delivery system of claim 42, wherein the cryogenic fluid is a non-toxic cryogenic liquid.

54. The cryogenic fluid delivery system of claim 53, wherein the cryogenic fluid is liquid nitrogen or liquid air.

55. The cryogenic fluid delivery system of claim 42, wherein the boiling chamber further comprises a safety arrangement configured to prevent liquid cryogenic fluid from leaving the system.

56. An air conditioning apparatus for use with a cryogenic fluid tank, comprising a housing having a tank receiving portion at a bottom end thereof configured to house a cryogenic fluid tank, a hollow neck extending vertically upwards from said tank receiving portion and configured to house at least a portion of the vaporizer module of the cryogenic fluid delivery system of claim 42, and a dispensing portion at an upper portion of the housing configured to house the at least one dispensing member of said cryogenic fluid delivery system.

57. The air conditioning apparatus of claim 56, wherein the neck comprises an elongation mechanism operable to increase and decrease the length of the neck, and respectively, increase and decrease the distance between the tank receiving portion and the dispensing portion.

58. The air conditioning apparatus of claim 56, wherein the neck is substantially narrower than the tank receiving portion and the dispensing head.

59. The air conditioning apparatus of claim 56, wherein the dispensing portion is configured to be positioned, at least in operation of the apparatus, at a distance of 1-3 meters above the tank receiving portion.

60. The air conditioning apparatus claim 56, wherein the apparatus further comprises a scale configured to measure the amount of cryogenic fluid stored within the cryogenic fluid tank.

61. The air conditioning apparatus of claim 56, wherein the air conditioning apparatus further comprises a cryogenic gas saving module configured to convey cold that is generated around the boiling chamber as a result of operation thereof to the exterior of the housing, while arresting cryogenic fluid flow towards the boiling.
